(19) United States
(12) Patent Application Publication
(10) Pub. No.: US 2010/0289751 A1
(43) Pub. Date: Nov. 18, 2010

(54) Operation method for a trackpad equipped with pushbutton function

(76) Inventor: Stephen Chen, Changhua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,490

(22) Filed: May 13, 2009

(51) Int. Cl. G06F 3/041

(52) U.S. Cl. 345/173

(57) ABSTRACT

An operation method for a trackpad equipped with pushbutton function aims to control operation of a screen in a cursor movement mode or a button input mode by detecting finger touch conditions on a trackpad. The method is adopted on a trackpad apparatus consisting of a touchpad movable up and down and a pushbutton located beneath the touchpad. The touchpad has at least one cursor zone and one button zone that are incorporated with the operation method to get conditions of the finger and the touchpad. The method includes at least the steps of: a. the finger touches the cursor zone and performs depressing or release depressing action to function as a cursor control command; b. the finger touches the cursor zone and slides into the button zone to do depressing or release depressing action to function as the cursor control command; c. the finger touches the button zone and slides into the cursor zone to do depressing or releasing depressing action to function as the cursor control command; d. the finger touches the cursor zone and slides into the button zone, and leaves the touchpad and then touches the previous spot of the button zone within a set time period to function as the cursor control command; and e. the finger directly touches the button zone and depresses without sliding to function as a button control command. Through the method of the invention users can control the cursor on the screen through the touchpad, and also enter the button control command through the touchpad. Thus user's labor of moving back and forth between the touchpad and a keyboard can be alleviated.

### BACKGROUND OF THE INVENTION

1. Field of the Invention

The present invention relates to an operation method for a trackpad equipped with pushbutton function that allows users to control a cursor on a screen through a touchpad and also use the touchpad to input button control commands to alleviate users' operation workload of moving back and forth between the touchpad and a keyboard.

2. Description of the Prior Art

There are a wide variety of cursor control means available at present. Among them, mouse is most commonly adopted. However, the mouse, in addition to the common function of controlling the cursor, also includes a common switch button to perform frequently used functions for browsing web pages or documents, such as scroll (upward, downward, leftward, rightward), zoom larger and smaller, page up and down, and the like. These functions usually also can be performed on a keyboard. However, each button on the keyboard has a set definition. To achieve the aforesaid function a composite button has to be used. This results in complicated operation and becomes a burden of memory for users.

Moreover, the mouse often has a fast key to provide a convenient interface for users. But the mouse cannot be installed on a notebook computer. The notebook computer generally employs a touchpad to perform mouse function. Due to constraint of usable area, the notebook computer usually has a touchpad and a left button and a right button, installing the fast key around the trackpad to perform frequently used function is difficult

Some trackpads provide a scroll area on a selected location, usually on the right edge or a lower edge to perform functions of scrolling upwards, downwards, leftwards and rightwards. Moving on the edge can perform scrolling. Some other trackpads provide a page up and down area on an upper edge. Sliding a finger leftwards on that area can issue a page up command, while sliding the finger rightwards can send a page down command. There are also trackpads that can detect touch and motion of two fingers. By splaying two originally contacted fingers can issue a zoom large command, while closing the two splayed fingers can issue a zoom small command.

The techniques mentioned above allow the trackpad of a limited area to perform fast key function. However, finger sliding motion is same as the motion of controlling cursor operation. As user's eyes have to look at the screen during cursor operation, to control precise finger position is difficult. In the event that the fingers inadvertently enter those areas of special functions, erroneous actions take place. Hence although the fast key provides some special functions and convenience, it also tends to create mistaken actions unexpectedly. The benefits it generates often cannot offset the troubles it creates. Moreover, the special functions provided by the fast key are difficult to be labeled and have to be memorized by the users. It hinders intuitive operation.

As a result, even though most notebook computers have a built-in trackpad, many people still prefer to add an external mouse to the notebook computer when in use. The mouse provides better cursor maneuverability and other functions that make operation and control easier.

Taiwan patent application 94209869 discloses an integrated touchpad module which has a touchpad with integrated function keys at the periphery. The touchpad is attached to a lower side of the casing. Adopting the touchpad module does not require forming an opening on the machine. No extra physical button is needed. It can be formed integrally to reduce cost and guard against water spraying and dust. The touchpad is divided into an upper zone and a lower zone. The upper zone is for cursor operation and the lower zone is for function keys.

Taiwan patent application 92205217 provides a capacitance touchpad with integrated button and handwriting input functions. It provides multiple operation modes, such as button, handwriting or mouse. The touch pad is defined in a plurality of segments printed with patterns corresponding to the operation modes. The patterns include a mode switch to allow users to select operation modes, such as in the button mode a button pattern is provided to function as a keyboard; in the handwriting mode a handwriting recognition segment is provided to receive handwriting input; and in the mouse mode a cursor movement segment and a horizontal and vertical rolling segment are provided.

Taiwan patent application 94216400 provides a button touchpad module which includes an insulation zone, a pliable touchpad and a button set. The pliable touchpad provides the characteristics of a flexible printed circuit board to give uniform light penetration of LEDs at the bottom of the button touchpad module so that users feel like pushing physical buttons to improve the nonlinear induction response happened to the touchpad.

Taiwan patent application 90106673 discloses a method for entering texts through a touchpad. It can function as a touchpad on a Note Book (NB) computer to do text input.

Taiwan patent application 94219497 provides a touch axle equipped with button function. It has a plurality of axle induction zones and at least one button induction zone. The button induction zone is located between neighboring axle induction zones. The area around the button induction zone is defined as a virtual button.

### SUMMARY OF THE INVENTION

The techniques adopted in the aforesaid references regarding controlling cursor movement on the screen cannot fully meet actual use requirements that demand fast moving of the cursor to a targeted position without overtaxing user's labor for moving fingers frequently back and forth between the touchpad and pushbuttons. Therefore the present invention aims to provide an operation method for a trackpad equipped with pushbutton function that can detect touch conditions of the fingers on the trackpad to control operation modes of the screen for cursor movement or button input. The method includes at least the following steps:

a. Finger touches a cursor zone, and performs action of depressing or release depressing, treated as a cursor control command;

b. After the finger has touched the cursor zone, slides into a button zone to perform action of depressing or release depressing, treated as a cursor control command;

c. After the finger has touched the button zone, slides into the cursor zone to perform action of depressing or release depressing, treated as the cursor control command;

d. After the finger has touched the cursor zone and slid into the button zone, and left the touchpad, and touches the same spot of the button zone again within a set time period to perform action of depressing or release depressing, treated as the cursor control command; and

e. The finger directly touches the button zone and depresses without sliding, treated as a button control command.

By means of the foregoing control steps the shortcomings of the conventional trackpad can be overcome, and operation is easier without overtaxing user's fingers.

At the step e, if the finger starts sliding over a set distance after having depressed the pushbutton of the touchpad, treated as controlling cursor movement.

At the step e, if the finger starts sliding after having depressed the pushbutton of the touchpad in the button zone from the scope of one pushbutton to the scope of another pushbutton, then perform depressing action, the final depressing spot is treated as button input.

At the step e, if the finger starts sliding after having depressed the pushbutton of the touchpad in the button zone in the direction of the button zone, treated as controlling cursor movement; if the finger slides towards a neighboring button zone, cursor moving function is not executed.

At the step e, if the finger depresses in the button zone without releasing within a set time period, execute cursor action (without executing button input).

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of a touchpad apparatus of the invention.

FIG. 2 is a schematic view of an embodiment of the touchpad according to the invention.

FIG. 3 is a flowchart of the control method of the invention.

FIG. 4 is a flowchart of an embodiment of the invention.

FIG. 5 is a chart showing operation sequence and corresponding results according to the invention.

### DESCRIPTION OF THE PREFERRED EMBODIMENTS

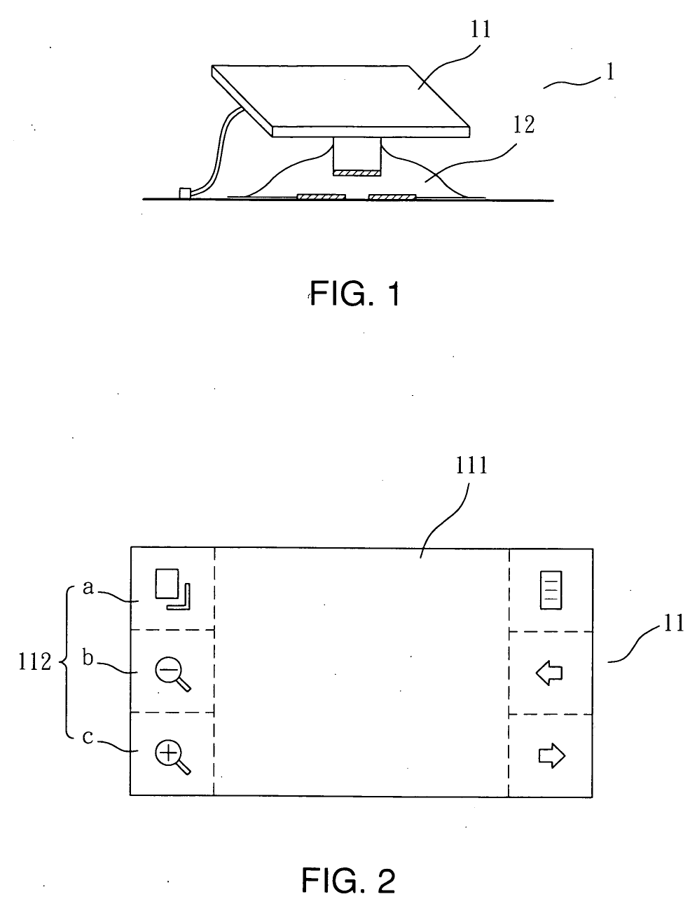

Please referring to FIGS. 1 and 2, to achieve the object of the invention the method 2 according to the invention detects finger touch conditions on a trackpad to control screen operation mode for cursor movement or button input. The method of the invention is implemented through a trackpad apparatus 1 consisting of a touchpad 11 and a pushbutton 12 located beneath the touchpad 11. The touchpad 11 has at least one cursor zone 111 and one button zone 112 (including at least one button a, b, and c).

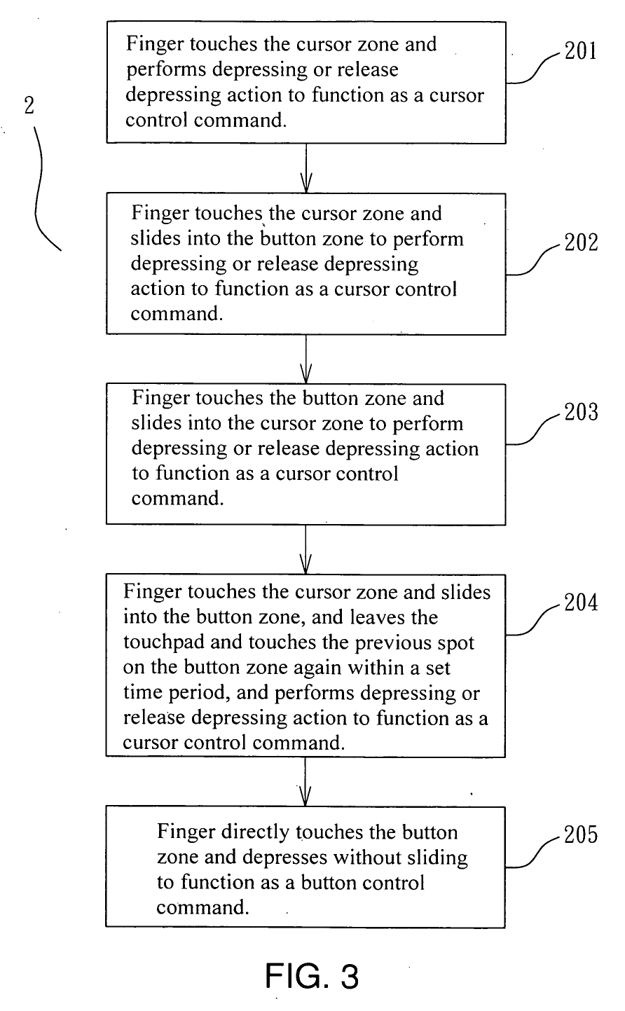

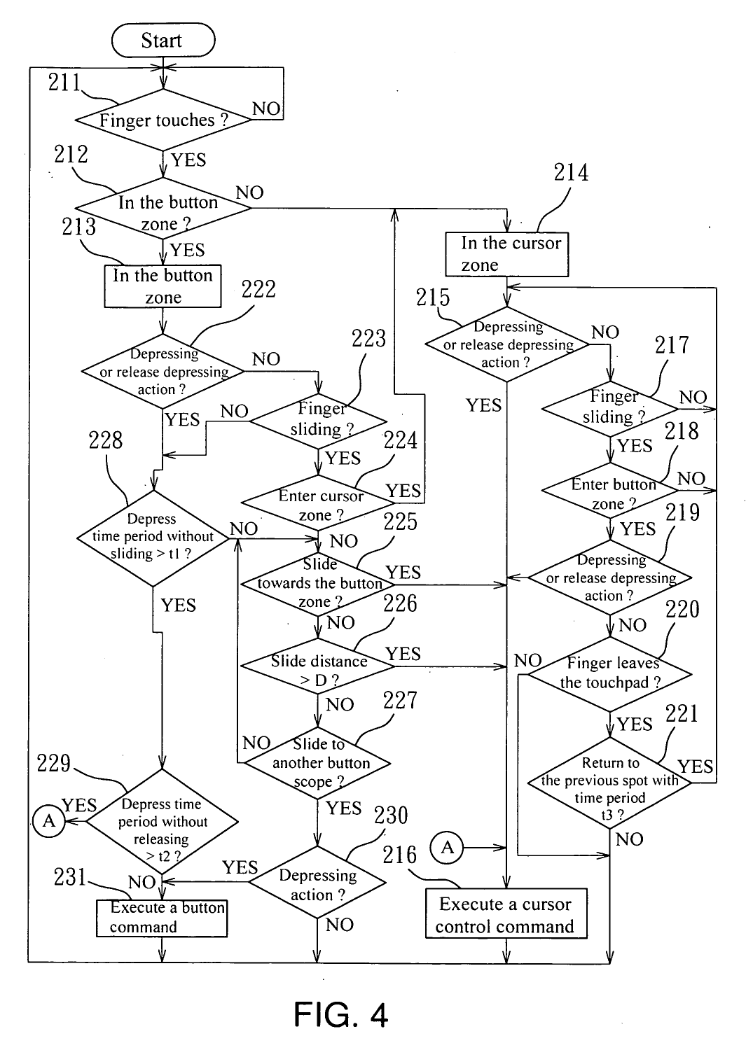

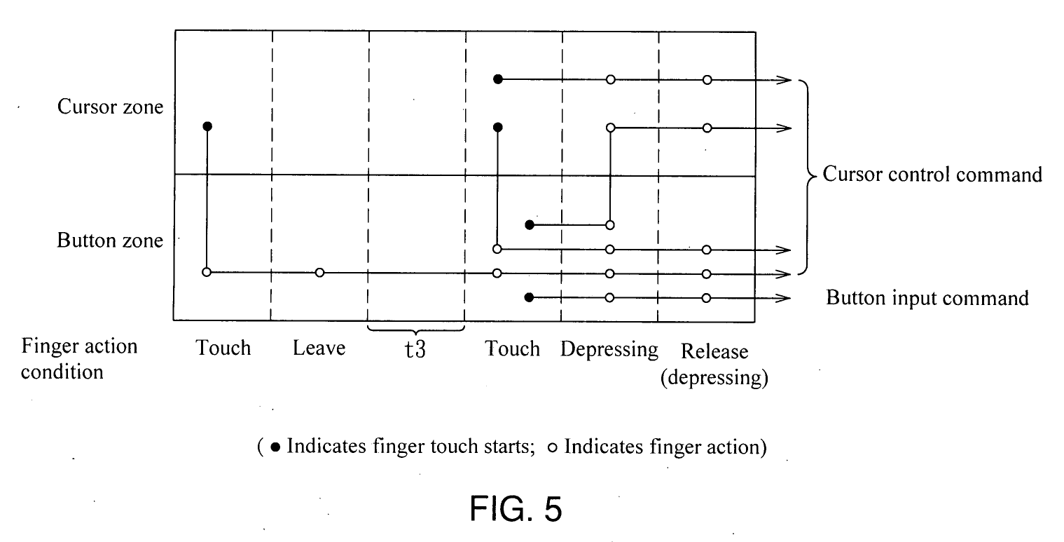

Under the basic structure of the trackpad apparatus 1, the invention provides the operation method 2 (referring to FIG. 3) which includes at least the steps as follow (also referring to FIG. 4 for the step flowchart and FIG. 5 for operation sequence and corresponding results):

a. Finger touches the cursor zone, and performs action of depressing or release depressing, treated as a cursor control command (step 201): The trackpad 1 detects finger touch (step 211) and judges whether the touched spot is in the button zone 112 (step 212); if positive (YES), the finger is in the button zone 112; if negative (NO), the finger is in the cursor zone 111; when the finger has touched, then performs continuous actions of depressing or releasing (after depressing) the pushbutton 12 (step 215), execute the cursor control command (step 216) to control cursor movement;

b. After the finger has touched the cursor zone, then slides into the button zone and performs action of depressing or release depressing, treated as a cursor control command (step 202): When the finger has touched the cursor zone 111 (step 214) and slid into the button zone 112 (steps 217 and 218), then depresses or releases (after depressing) the pushbutton 12 (step 219), execute the cursor control command (step 216);

c. After the finger has touched the button zone and slid into the cursor zone to perform action of depressing or release depressing, treated as a cursor control command (step 203): When the finger has slid from the button zone (step 213) into the cursor zone 111 (steps 222, 223, 224 and 214), then depresses or releases (after depressing) the pushbutton 12 (step 215), execute the cursor control command (step 216);

d. After the finger has touched the cursor zone and slid into the button zone, and left the touchpad, and touches the same spot of the button zone again within a set time period to perform depressing or releasing (after depressing) action, treated as a cursor control command (step 204): When the finger has slid from the cursor zone 111 (step 214) into the button zone 112 (steps 215, 217 and 218), and moved away from the touchpad 11 (steps 219 and 220) within a set time period t3, then returns to the same spot (step 221) and depresses or releases (after depressing) the pushbutton 12 (step 215), execute the cursor control command (step 216);

e. The finger directly touches the button zone and depresses without sliding, treated as the button control command (step 205): When the finger depresses the touchpad 11 on the button zone 112 (step 213) without sliding for a time period longer than a first set time period t1 and without releasing depression for a time period smaller than a second set time period t2 (steps 222, 228 and 229), execute the button command (step 231) and perform button input function.

At the step e, if the finger starts sliding after having depressed the pushbutton 12 of the touchpad 11 (NO at step 228) in and towards the button zone 112, treated as controlling cursor movement (steps 225 and 216); on the other hand, if the finger slides towards a neighboring button zone, no cursor moving function is executed (NO at step 225).

At the step e, if the finger starts sliding after having depressed the pushbutton 12 of the touchpad 11 (NO at step 228) in the button zone 112 over a set distance D (step 226), execute the cursor control command (step 216).

At the step e, if the finger starts sliding after having depressed the pushbutton 12 of the touchpad 11 (NO at step 228) in the button zone 112 from the scope of one button a to the scope of another button b (step 227), then performs depressing action at the final spot, the final depressing spot is treated as button input (steps 230 and 231). The methods previously discussed, aside from controlling cursor movement, also provides switching and controlling button command functions in a short time period.

As a conclusion, the invention provides an operation method for a trackpad equipped with pushbutton function. Aside from allowing users to control cursor on the screen through the trackpad apparatus, button commands can be entered through the touchpad to alleviate the workload of users from moving back and forth between the touchpad and keyboard. Operation is much easier.

I claim:

1. An operation method for a trackpad equipped with pushbutton function operable on a trackpad apparatus which has a touchpad movable up and down and having at least one cursor zone and one button zone and a pushbutton beneath the touchpad, the method comprising at least the steps of:
a. touching the cursor zone by a user's finger and depressing or releasing the depressing to function as a cursor control command;
b. touching the finger on the cursor zone and sliding the finger into the button zone to perform the depressing or the releasing the depressing to function as the cursor control command;
c. touching the finger on the button zone and sliding the finger into the cursor zone to perform the depressing or the releasing the depressing to function as the cursor control command;
d. touching the finger on the cursor zone and sliding the finger into the button zone and leaving the finger from the touchpad and touching the finger on a previous touching spot on the button zone again within a set time period and performing the depressing or the releasing the depressing to function as the cursor control command, and
e. touching directly the button zone and depressing without sliding to function as a button control command

2. The operation method of claim 1, wherein at the step e the finger starts sliding in the button zone to exceed a set distance after depressing of the pushbutton with the finger through the touchpad to function as control cursor movement.

3. The operation method of claim 1, wherein at the step e the finger starts sliding in the button zone from a scope of one pushbutton to another scope of another pushbutton after having depressed the pushbutton through the touch pad to perform the depressing at a final depressing spot which functions as a button input.

4. The operation method of claim 1, wherein at the step e the finger starts sliding in the button zone towards the button zone after having depressed the pushbutton with the finger through the touchpad to function as controlling cursor movement; sliding of the finger towards a neighboring button zone not functioning as the controlling cursor movement.

5. The operation method of claim 1, wherein at the step e the finger depresses the button zone for a time period longer than a first set time period to execute button input.

6. The operation method of claim 1, wherein at the step e the finger depresses the button zone without releasing for a time period smaller than a second set time period to execute button input.
